(19) United States
(12) Patent Application Publication
(10) Pub. No.: US 2023/0262134 A1
(43) Pub. Date: Aug. 17, 2023

(54) METHODS AND SYSTEMS FOR MANAGING RELOCATION OF AN EDGE ENABLER CLIENT CONTEXT INFORMATION

(71) Applicant: Samsung Electronics Co., Ltd., Suwon-si Gyeonggi-do (KR)

(72) Inventors: Narendranath Durga TANGUDU, Bangalore (IN); Nishant GUPTA, Bangalore (IN); Sapan Pramodkumar SHAH, Bangalore (IN); Basavaraj Jayawant PATTAN, Bangalore (IN)

(21) Appl. No.: 18/015,238

(22) PCT Filed: Jul. 23, 2021
(86) PCT No.: PCT/KR2021/009598

§ 371 Date: Jan. 9, 2023

(30) Foreign Application Priority Data
Jul. 24, 2020 (IN) 202041031792
Jul. 19, 2021 (IN) 2020 41031792

(51) Int. Cl. H04L 67/148; H04L 67/55; H04L 67/02; H04L 67/125

(52) U.S. Cl. CPC H04L 67/148; H04L 67/55; H04L 67/02; H04L 67/125

(57) ABSTRACT

The present disclosure relates to a communication method and system for converging a 5th-Generation (5G) communication system for supporting higher data rates beyond a 4th-Generation (4G) system with a technology for Internet of Things (IoT). The present disclosure may be applied to intelligent services based on the 5G communication technology and the IoT-related technology, such as smart home, smart building, smart city, smart car, connected car, health care, digital education, smart retail, security and safety services. Embodiments herein disclose methods and systems for managing relocating EEC context information from a source EES (108) or from an EEC (104) of a user device (102), according to embodiments as disclosed herein. The target EES (108) includes an edge enabler client (EEC) controller (210), a communicator (220), a memory (230), a processor (240), and an EAS controller (250). The EEC controller (210) is configured to maintain an EEC context information about the EEC, based on at least one of EEC registration on the source EES, the EEC requesting a subscription for an edge enabler service with the source EES, or by receiving the EEC context information from another source EES. The EEC controller (210) is further configured to detect a need to relocate the EEC context information to target EES. The EEC controller (210) is further configured to relocate the EEC context information to the target EES.

### TECHNICAL FIELD

Embodiments disclosed herein relate to edge computing systems, and more particularly to handling failure in edge service continuity in the edge computing systems.

### BACKGROUND ART

To meet the demand for wireless data traffic having increased since deployment of 4G communication systems, efforts have been made to develop an improved 5G or pre-5G communication system. Therefore, the 5G or pre-5G communication system is also called a ‘Beyond 4G Network’ or a ‘Post LTE System’. The 5G communication system is considered to be implemented in higher frequency (mmWave) bands, e.g., 60 GHz bands, so as to accomplish higher data rates. To decrease propagation loss of the radio waves and increase the transmission distance, the beamforming, massive multiple-input multiple-output (MIMO), Full Dimensional MIMO (FD-MIMO), array antenna, an analog beam forming, large scale antenna techniques are discussed in 5G communication systems. In addition, in 5G communication systems, development for system network improvement is under way based on advanced small cells, cloud Radio Access Networks (RANs), ultra-dense networks, device-to-device (D2D) communication, wireless backhaul, moving network, cooperative communication, Coordinated Multi-Points (CoMP), reception-end interference cancellation and the like. In the 5G system, Hybrid FSK and QAM Modulation (FQAM) and sliding window superposition coding (SWSC) as an advanced coding modulation (ACM), and filter bank multi carrier (FBMC), non-orthogonal multiple access(NOMA), and sparse code multiple access (SCMA) as an advanced access technology have been developed.

The Internet, which is a human centered connectivity network where humans generate and consume information, is now evolving to the Internet of Things (IoT) where distributed entities, such as things, exchange and process information without human intervention. The Internet of Everything (IoE), which is a combination of the IoT technology and the Big Data processing technology through connection with a cloud server, has emerged. As technology elements, such as “sensing technology”, “wired/wireless communication and network infrastructure”, “service interface technology”, and “Security technology” have been demanded for IoT implementation, a sensor network, a Machine-to-Machine (M2M) communication, Machine Type Communication (MTC), and so forth have been recently researched. Such an IoT environment may provide intelligent Internet technology services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing Information Technology (IT) and various industrial applications.

In line with this, various attempts have been made to apply 5G communication systems to IoT networks. For example, technologies such as a sensor network, Machine Type Communication (MTC), and Machine-to-Machine (M2M) communication may be implemented by beamforming, MIMO, and array antennas. Application of a cloud Radio Access Network (RAN) as the above-described Big Data processing technology may also be considered to be as an example of convergence between the 5G technology and the IoT technology.

In line with the development of communication systems, a communication system that can provide edge computing services has been introduced. 3^{rd} generation partnership project (3GPP) TS 23.558 defines the application layer architecture, procedures and information flows necessary for enabling edge applications over 3GPP networks. It includes architectural requirements for enabling edge applications, application layer architecture fulfilling the architecture requirements and procedures to enable the deployment of edge applications. Edge Enabler Server (EES) provides supporting functions needed for Edge Application Servers and Edge Enabler Client. Edge Enabler Client (EEC) provides supporting functions needed for Application Client(s). 3GPP TS 23.558 specifies the registration of Edge Enabler Client with the EES. This procedure enables the initialization or update of the Edge Enabler Client context information at the Edge Enabler Server. In the registration request message to the target EES i.e., the EES to which the EEC intends to register, the Edge Enabler Client includes the Edge Enabler Client EEC Context ID from the source EES, and the source EES information. The EEC receives the EEC Context ID from the source EES i.e., the EES with which the EEC is currently registered with, after successful registration of Edge Enabler Client with the source EES. During the registration procedure, if the request included EEC Context ID and the source EES information, then the target EES relocates the EEC's context information from the source EES, using the EEC Context ID reference from the EEC.

The EEC Context information can also be relocated to the target EES as part of Application Context Relocation (ACR) procedures performed to maintain application level service continuity. In this case the EEC can provide the EEC Context ID to the EES as part of the ACR request.

The context information of the EEC with EES may include subscriptions of the EEC, selection criteria for selecting the target EAS in case of service continuity and like so. Throughout this document, the context information means the same.

### DISCLOSURE OF INVENTION

### Technical Problem

In the above mentioned registration procedure, when the target EES is not able to relocate the EEC context information from the source EES, for various possible reasons like, non-availability of context information at source EES, the source EES is not reachable by the target EES etc., then the context information of the EEC is not established by the target EES. Failure to establish the context information of the EEC, leads to service discontinuity of the EEC, which in turn may result in service discontinuity of the Application Clients leveraging the Edge computing services.

The above stated problem is also applicable in the scenario, when a target Edge Application Server fails to relocate the application client's context information from the source Edge Application Server, which may lead to the Edge Application's service discontinuity.

### Solution to Problem

Accordingly, the embodiments herein provide a method for managing relocating an Edge Enabler Client (EEC) context information. The method includes maintaining, by a source Edge Enabler Server (EES), an EEC context information about the EEC, based on at least one of EEC registration on the source EES, the EEC requesting a subscription for an edge enabler service with the source EES, or by receiving the EEC context information from another source EES. The method further includes detecting, by the source EES, a need to relocate the EEC context information to target EES. The method further includes relocating, by the source EES, the EEC context information to the target EES.

Embodiments herein further disclose the method providing, by the EES, an EEC context relocation status in response to the relocation of the EEC context information. The method further includes reconstructing, by the target EES, the EEC context information when the EEC context relocation failed.

Embodiments herein further disclose the EES detects the need for relocation based on at least one of a request from the EEC, a request from the Edge Application Server, a request from another EES or detecting mobility of the UE hosting the EEC.

Embodiments herein further disclose the EEC context relocation status comprise of one of successful status or failed status of relocation.

Embodiments herein further disclose the EEC context relocation status is provided to the EEC by the source EES as part of an Application Context Relocation (ACR) complete notification.

Embodiments herein further disclose the EEC context relocation status is provided to the EEC or an Edge Application Server (EAS) by the target EES in response to one of the EEC registration request or the Application Context Transfer (ACT) status update request.

Embodiments herein further disclose the EEC on receiving the failed EEC context relocation status, performs necessary operations. The necessary operations comprises subscribing for required events, to help reconstruct the EEC context information at the target EES.

In an aspect, the embodiments herein provide a system. The system includes a user device, a target edge enabler server (EES), and a source EES. The source edge enabler server includes an edge enabler client (EEC) controller. The EEC controller is configured to maintain an EEC context information about the EEC, based on at least one of EEC registration on the source EES, the EEC requesting a subscription for an edge enabler service with the source EES, or by receiving the EEC context information from another source EES. The EEC controller is further configured to detect a need to relocate the EEC context information to target EES. The EEC controller is further configured to relocate the EEC context information to the target EES.

Embodiments herein further disclose the EEC controller is further configured to provide an EEC context relocation status in response to the relocation of the EEC context information. The EEC controller is further configured to reconstruct the EEC context information when the EEC context relocation failed

Embodiments herein further disclose the EES detects the need for relocation based on at least one of a request from the EEC, a request from the Edge Application Server, a request from another EES or detecting mobility of the UE hosting the EEC.

Embodiments herein further disclose the EEC context relocation status comprise of one of successful status or failed status of relocation.

Embodiments herein further disclose the EEC context relocation status is provided to the EEC by the source EES as part of an Application Context Relocation (ACR) complete notification.

Embodiments herein further disclose the EEC context relocation status is provided to the EEC or an Edge Application Server (EAS) by the target EES in response to one of the EEC registration request or the Application Context Transfer (ACT) status update request.

Embodiments herein further disclose the EEC on receiving the failed EEC context relocation status, performs necessary operations. The necessary operations comprises subscribing for required events, to help reconstruct the EEC context information at the target EES.

These and other aspects of the embodiments herein will be better appreciated and understood when considered in conjunction with the following description and the accompanying drawings. It should be understood, however, that the following descriptions, while indicating at least one embodiment and numerous specific details thereof, are given by way of illustration and not of limitation. Many changes and modifications may be made within the scope of the embodiments herein without departing from the spirit thereof, and the embodiments herein include all such modifications.

### Advantageous Effects of Invention

According to the embodiments of the disclosure, the following objects can be achieved.

The principal object of the embodiments herein is to disclose an Edge Enabler Server (EES) to establish an Edge Enabler Client (EEC) context information in the event of failure of relocating the EEC context information from a source EES, without rejecting or failure of the EEC registration. In an embodiment, the EES achieves this by sharing the EEC context relocation status with the EEC, enabling EEC to take corrective actions for subscriptions over EDGE-1 interface. In another embodiment, the EES also shares the EEC context relocation status with the EAS, enabling EAS to take corrective actions for capability exposure APIs over EDGE-3 interface.

Another object of the embodiments herein is to disclose the target EES proceeding further to reconstruct the EEC context information, and with successful registration upon reconstruction of the EEC's context information, on encountering a context relocation failure.

Another object of the embodiments herein is to disclose the EES, configured to indicate the Edge Enabler Client of context relocation failure and proceed with construction of EEC context. The target EES server constructs the EEC context information, either with assistance from EEC or managed by the target EES. In an embodiment, the source EES shares this EEC context relocation status with the EEC as part of the Application Context Relocation procedures. In another embodiment, the target EES shares this EEC context relocation status with the EEC and/or the EAS as part of the Application Context Relocation procedures or with the EEC as part of the EEC registration procedure.

Another object of the embodiments herein is to disclose a method for the EEC to construct the EEC context and share it to the target EES to support context reconstruction.

Another object of the embodiments herein is to disclose a method for the target EES to construct the EEC context by querying the local context from the EEC and use the local context to construct new context.

### BRIEF DESCRIPTION OF DRAWINGS

The embodiments disclosed herein are illustrated in the accompanying drawings, throughout which like reference letters indicate corresponding parts in the various figures. The embodiments herein will be better understood from the following description with reference to the drawings, in which:

FIG. 1 depicts a system view for relocating an Edge Enabler Client (EEC) context information, according to embodiments as disclosed herein;

FIG. 2 shows various hardware components of a target edge enabler server (EES) for relocating the EEC context information from a source EES or from the EEC of a user device, according to embodiments as disclosed herein;

FIG. 3 depicts a process of context construction with assistance from EEC after registration response, according to embodiments as disclosed herein;

FIG. 4 depicts a process of context construction with assistance from the EEC before registration response, according to embodiments as disclosed herein;

FIG. 5 depicts a process of EES managed context information construction with help of the EEC or the EAS, according to embodiments as disclosed herein;

FIG. 6 depicts a process of target EES or source EEC managed context information construction with help of the EEC or the EAS, according to embodiments as disclosed herein; and

FIG. 7 depicts a method for managing relocating an Edge Enabler Client (EEC) context information, according to embodiments as disclosed herein.

### MODE FOR THE INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein can be practiced and to further enable those of skill in the art to practice the embodiments herein. Accordingly, the examples should not be construed as limiting the scope of the embodiments herein.

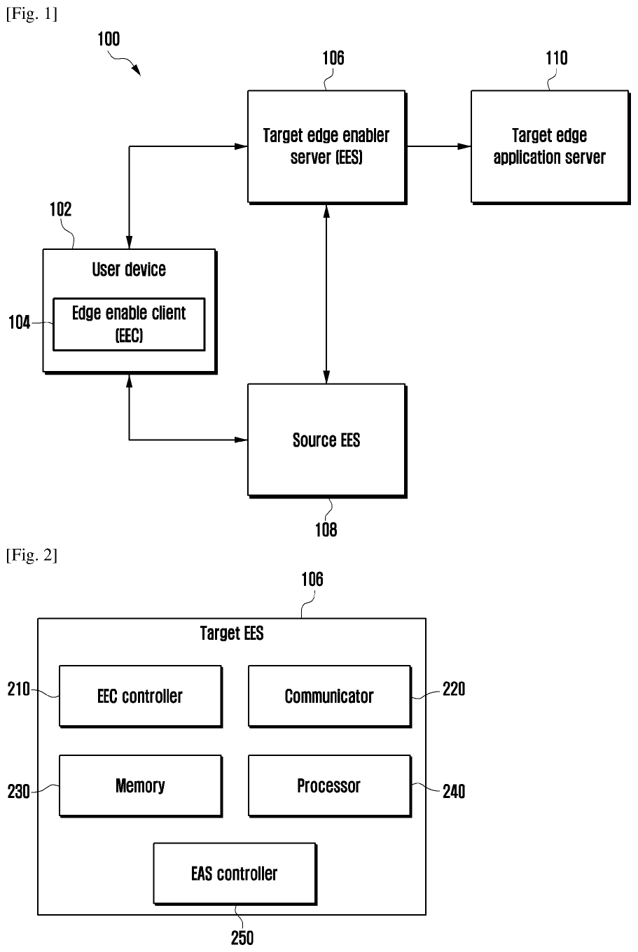

The embodiments herein achieve methods and system managing relocating an Edge Enabler Client (EEC) context information by handling failure in edge service continuity. Referring now to the drawings, and more particularly to FIGS. 1 through 7, where similar reference characters denote corresponding features consistently throughout the figures, there are shown at least one embodiment.

Embodiments herein disclose an Edge Enabler Server (EES), configured to establish an Edge Enabler Client (EEC) context in an event of failure of relocating an EEC's context information from a source EES, without rejecting or failure of Edge Enabler Client registration. Embodiments herein disclose the target EES proceeding further to reconstruct the EEC context information, and with successful registration upon reconstruction of the EEC's context information, on encountering a context relocation failure. Embodiments herein disclose the EES, configured to indicate the Edge Enabler Client of the context relocation failure and proceed with construction of the EEC context. The target EES server constructs the EEC context information, either with assistance from EEC or managed by the target EES. Embodiments herein disclose a method for the EEC to construct the EEC context and share it to the target EES to support context reconstruction. Embodiments herein disclose a method for the EES to construct the EEC context by querying the local context from the EEC and use the local context to construct new context. Embodiments herein disclose a method for EES to share the EEC context relocation status with the EEC or EAS to indicate that the corrective measures are needed as EEC context relocation failed.

Embodiments herein disclose methods for an EES to establish the EEC context in the event of failure of relocating the EEC context information. Embodiments herein enable the target EES server to construction of the context information of the EEC, either with assistance from EEC or managed by the target EES. Instead of rejecting the registration request from the EEC, due to the context relocation failure, the target EES proceeds with the registration and further reconstructs the EEC context information.

Embodiments herein are also applicable to service continuity during change of Edge Application Server, where in the illustrated solutions, Edge Enabler Client is Application Client and EES is Edge Application Server.

Embodiments herein also propose a format for the EEC Context ID, so that they are identifiable, and unique across Edge Enabler servers. Such a structured format to EEC context ID enables the possessor of the EEC Context ID to identify the EES that has generated the EEC Context ID and such information shall enable the possessing entity to reach to the appropriate EES to relocate the context information. Embodiments herein may use any of the EEC Context ID formats below.

a. <Context ID>“separator”<Identifier of the EES that generated the Context>; for example: 123abcd45@enablerserver.domain.com, 123abcd45@enablerserverID

b. <Context ID>“separator”<Identifier of EES or EAS>“separator”<Edge server type “EES”/“EAS”>“separator”<Edge Computing Service Provider ID>; for example: 678asd123@enablerserverID@EES@ecspID

c. Uniform Resource Identifier (URI) format, as per IETF RFC 3986 (Uniform Resource Identifier (URI): Generic Syntax) with the format such as <EES ID>“separator”<ECSP ID>“separator”<Context ID>; for example: edgeEnablerServerID.edgeComputingServiceProviderID.com/contextID.

In an alternate embodiment, the EEC context relocation status can be named differently, such as EDGE-3 context relocation status or EDGE-3 initialization status when sent to an Edge Application Server.

FIG. 1 depicts a system 100 view for relocating an Edge Enabler Client (EEC) context information, according to embodiments as disclosed herein. The system 100 includes a user device 102, a target EES 106, a source EES 108, and a target edge application server (EAS) 110. The user device 102 includes the EEC 104. When the user device is using an edge enabler service, the EEC 104 can communicate with the target EES 106 or the source EES 108. The target EAS(110) can communicate with the target EES (106). The user device 102 can be, for example, but not limited to, a cellular phone, a smart phone, a smart watch, a Personal Digital Assistant (PDA), a tablet computer, a laptop computer, a virtual reality device, an immersive system, an Internet of Things (IoT) device, or any other device capable using 3GPP.

FIG. 2 shows various hardware components of a target EES for relocating the EEC context information from a source EES or from the EEC of a user device, according to embodiments as disclosed herein. The target EES 108 includes an EEC controller 210, a communicator 220, a memory 230, a processor 240, and a EAS controller 250. The EEC controller 210 maintain an EEC context information about the EEC, based on at least one of EEC registration on the source EES, the EEC requesting a subscription for an edge enabler service with the source EES, or by receiving the EEC context information from another source EES. The EEC controller is further configured to detect a need to relocate the EEC context information to target EES. The EEC controller is further configured to relocate the EEC context information to the target EES. The EEC controller is further configured to provide an EEC context relocation status to the EEC in response to the relocation of the EEC context information. The EEC controller is further configured to reconstruct the EEC context information when the EEC context relocation failed. The EAS controller is configured to provide an EEC context relocation status to the EAS in response to the relocation of the EEC context information.

In an embodiment, the source EES 108 includes the EEC controller 210, a communicator 220, a memory 230 and a processor 240.

Embodiments herein further disclose the EES detects the need for relocation based on at least one of a request from the EEC, a request from the Edge Application Server, a request from another EES or detecting mobility of the UE hosting the EEC. The EEC context relocation status comprise of one of successful status or failed status of relocation and like so. The EEC context relocation status is provided to the EEC by the source EES as part of an Application Context Relocation (ACR) complete notification. The EEC context relocation status is provided to the EEC or an Edge Application Server (EAS) by the target EES in response to one of the EEC registration request or the Application Context Transfer (ACT) status update request. The EEC or the EAS on receiving the failed EEC context relocation status, perform necessary operations. The necessary operations comprises subscribing for required events, to help reconstruct the EEC context information at the target EES. In an alternate embodiment, the ACT status update message can be replaced with Application Context Relocation status message.

Further, the processor 240 is configured to execute instructions stored in the memory 230 and to perform various processes. The communicator 220 is configured for communicating internally between internal hardware components and with external devices via one or more networks. The memory 230 also stores instructions to be executed by the processor 240. The memory 230 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 230 may, in some examples, be considered a non-transitory storage medium. The term “non-transitory” may indicate that the storage medium is not embodied in a carrier wave or a propagated signal. However, the term “non-transitory” should not be interpreted that the memory 230 is non-movable. In certain examples, a non-transitory storage medium may store data that can, over time, change (e.g., in Random Access Memory (RAM) or cache).

At least one of the plurality of modules may be implemented through the Artificial Intelligence (AI) model. A function associated with the AI model may be performed through the non-volatile memory, the volatile memory, and the processor 240. The processor 240 may include one or a plurality of processors. At this time, one or a plurality of processors may be a general purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU).

The one or a plurality of processors control the processing of the input data in accordance with a predefined operating rule or artificial intelligence (AI) model stored in the non-volatile memory and the volatile memory. The predefined operating rule or artificial intelligence model is provided through training or learning.

Here, being provided through learning means that a predefined operating rule or the AI model of a desired characteristic is made by applying a learning algorithm to a plurality of learning data. The learning may be performed in a device itself in which AI according to an embodiment is performed, and/o may be implemented through a separate server/system.

The AI model may comprise of a plurality of neural network layers. Each layer has a plurality of weight values and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

The learning algorithm is a method for training a predetermined target device (for example, a robot) using a plurality of learning data to cause, allow, or control the target device to make a determination or prediction. Examples of learning algorithms include, but are not limited to, supervised learning, unsupervised learning, semi-supervised learning, or reinforcement learning.

Although the FIG. 2 shows various hardware components of the target EES 106, it is to be understood that other embodiments are not limited thereon. In other embodiments, the target EES 106 may include less or a greater number of components. Further, the labels or names of the components are used only for illustrative purpose and does not limit the scope of the invention. One or more components can be combined together to perform the same or a substantially similar function in the target EES 106.

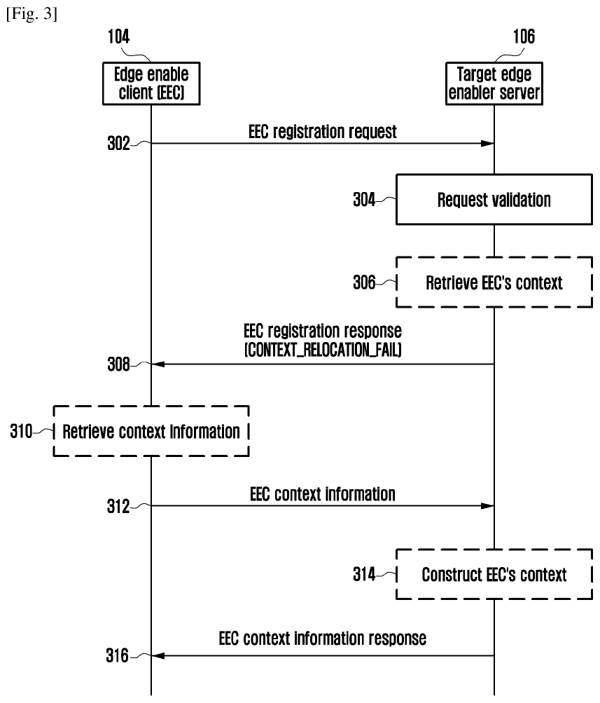

FIG. 3 depicts a process of the context construction with assistance from the EEC 104 after registration response. At step 302, the EEC 104 sends an EEC registration request to the target EES 106. When the EEC is moving from the purview of the source EES 108 to the target EES 106, the request from the EEC includes the identity of the source EES 108 and an EEC context ID that was provided by the source EES 108. Upon receiving the request from the EEC, at step 304, the target EES validates by authenticating and authorizing the sender of the registration request. On successful validation of the registration request, if the received registration request contains an EEC Context ID and a source EES identifier, then at step 306, the target EES relocates the EEC context from the source EES 108. At step 308, the target EES 106 sends a successful registration response, which may include a newly assigned EEC Context ID, other applicable parameters like registration expiration value. If the target EES 106 is not able to relocate the context information from the source EES 108, then the EES 106 shall additionally include an indication (CONTEXT_RELOCATION_FAIL) that the context information relocation has failed, along with other applicable parameters in the registration response message to the EEC. The EEC stores the new EEC Context ID and uses it if it needs to register with a new EES. If the EEC receives in the registration response message, an indication (CONTEXT_RELOCATION_FAIL) that the context information relocation has failed, then the EEC shall respond to the EES with the context information that is available locally at the EEC.

In some embodiments, the EEC may also relocate its context information from the source EES (that is periodically synchronized with the EES or relocated either at the time of initiating switching to the new EES or upon receiving context information relocation failed indication from the new EES) and include the received context information from the source EES in the Context Information message to the target EES.

In some embodiments, at step 312, the EEC may include the context information in the EEC Registration Update message to the EES. Upon receipt of the context information from the EEC, at step 314, the EES shall use this information from the EEC to construct the EEC's context information and map it to the EEC Context ID that was shared by EES in the successful registration response message. The EES server can send the constructed EEC context information in the Context Information response message.

In some embodiments, at step 316, the EES responds to the EEC with EEC Registration Update Response message, if the EEC has sent the context information in the EEC Registration Update message.

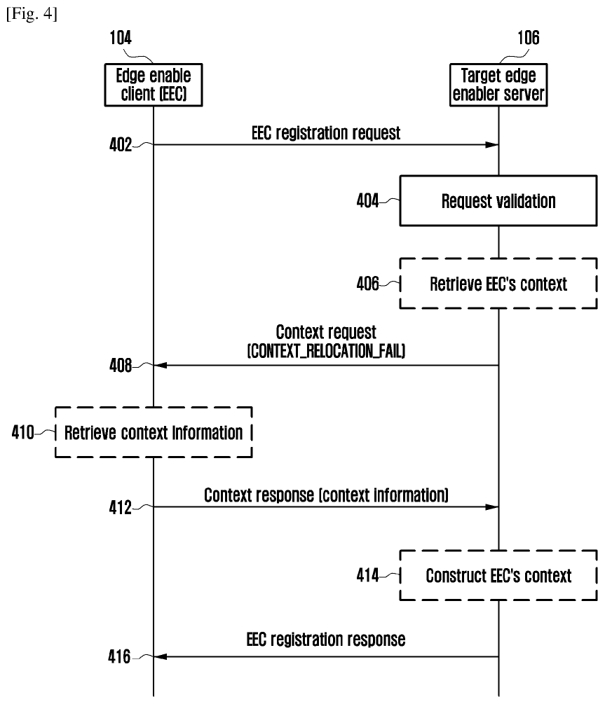

FIG. 4 depicts a process of context construction with assistance from the EEC before registration response. At step 402, the EEC sends an EEC Registration request to the EES. When the EEC is moving from the purview of a source EES to this target EES, the request from the EEC includes the identity of the source EES and an EEC Context ID that was provided by the source EES. Upon receiving the request from the EEC, at step 404, the target EES validates the registration. On successful validation of the registration request, if the received Registration request contains a EEC Context ID and a source EES Identifier, at step 406, the target EES relocates the EEC Context from the source EES. If the EES is not able to relocate the context information from the source EES, then at step 408, the EES shall send a context request message to the EEC indicating (CONTEXT_RELOCATION_FAIL) that the context information relocation has failed. If the EEC receives in the context request message with an indication (CONTEXT_RELOCATION_FAIL) that the context information relocation has failed, then the EEC at step 412 shall respond to the EES with the context information that is available at EEC. Upon receipt of the context information from the EEC, the EES at step 414 shall use this information from EEC to construct EEC's context information. The EES at step 416 sends a successful registration response, which may include a newly assigned EEC Context ID, other applicable parameters like registration expiration value. The EEC stores the new EEC Context ID and uses the EEC store when needed to register with a new EES.

In some embodiments, the target EES, may request for specific information related to the context of the EEC in the context request message along with the failure indication (CONTEXT_RELOCATION_FAIL). Upon receipt of such request, at step 412, the EEC shall respond context information to the EES, if available, with the specific information requested by the EES.

In some embodiments, the EEC may also relocate its context information from the source EES (that is periodically synchronized with the EES or relocated either at the time of initiating switching to the new EES or upon receiving context information relocation failed indication from the new EES) and include the received context information from the source EES in the Context Response message to the target EES. The EES shall use this information to construct the EEC's context information.

The various actions, acts, blocks, steps, or the like in the flow diagrams (FIGS. 3 and 4) may be performed in the order presented, in a different order or simultaneously. Further, in some embodiments, some of the actions, acts, blocks, steps, or the like may be omitted, added, modified, skipped, or the like without departing from the scope of the invention.

The embodiments disclosed herein can be implemented through at least one software program running on at least one hardware device and performing network management functions to control the elements. The elements can be at least one of a hardware device, or a combination of hardware device and software module.

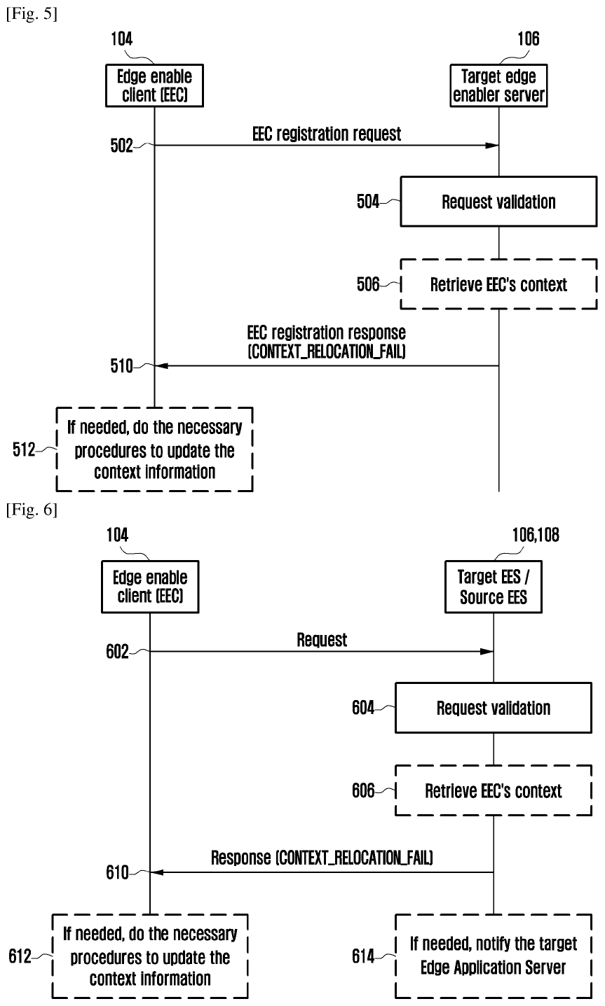

FIG. 5 depicts a process of EES managed context information construction with help of the EEC and/or the EAS. At step 502, the EEC sends a request to the EES. In an embodiment the EEC sends an EEC registration request to the target EES wherein the request includes the EEC context ID and the source EES ID for EEC context relocation. In an alternate embodiment the EEC sends an Application Context Relocation request to the source EES or the target EES wherein when sent to the source EES the request includes the target EES and target EAS information and when sent to the target EES the request includes the EEC context ID and the source EES ID for EEC context relocation. At step 504, the EES validates the request by authenticating and authorizing the sender. At step 506, the EES attempts to relocate the EEC context. When performed by source EES, the EEC context is pushed to the target EES and when performed by the target EES the EEC context is pulled from the source EES. At step 510, the EES sends the response to the EEC which includes the status of EEC context relocation. The response, may include a newly assigned EEC Context ID, context relocation failure indication (CONTEXT_RELOCATION_FAIL), newly constructed context information and other applicable parameters like registration expiration value etc. In an embodiment the source EES sends the response as part of the ACR response. In an alternate embodiment the target EES sends the response as part of the EEC registration response or the ACR response. If the target EES is not able to relocate the context information from the source EES, then the target EES can create new context information for the EEC, based on the information available in the request (such as Application client Profile(s) information) and information about the EEC. At step 512, the EEC stores the new EEC Context ID and stores it for future use, such as to register with a new EES later on. If the EEC receives in the response message, an indication (CONTEXT_RELOCATION_FAIL) that the context information relocation has failed, then the EEC may take necessary steps to update the context information like, create the needed subscriptions, inform target EES with additional information and the like.

In some embodiments, the EEC context relocation status can be called as EDGE-3 context relocation status or EDGE-3 initialization status etc.

In some embodiments, during EEC Registration request, the EEC may also include the EEC's context information available locally with EEC (that is periodically synchronized with the EES or relocated either at the time of initiating switching to the new EES or upon receiving context information relocation failed indication from the new EES), along with other applicable parameters, in the EEC registration request message. This context information from EEC, may be used by the EES in the event of EEC's context relocation failure, to construct the EEC's context information.

FIG. 6 depicts a process of target EES or source EEC managed context information construction with help of the EEC or the EAS, according to embodiments as disclosed herein. At step 602, the EEC sends a request to the EES. In an embodiment the EEC sends an EEC registration request to the target EES wherein the request includes the EEC context ID and the source EES ID for EEC context relocation. In an alternate embodiment the EEC sends an Application Context Relocation request to the source EES or the target EES wherein when sent to the source EES the request includes the target EES and target EAS information and when sent to the target EES the request includes the EEC context ID and the source EES ID for EEC context relocation. At step 604, the EES validates the request by authenticating and authorizing the sender. At step 606, the EES attempts to relocate the EEC context. When performed by source EES, the EEC context is pushed to the target EES and when performed by the target EES the EEC context is pulled from the source EES. At step 610, the EES sends the response to the EEC which includes the status of EEC context relocation. The response, may include a newly assigned EEC Context ID, context relocation failure indication (CONTEXT_RELOCATION_FAIL), newly constructed context information and other applicable parameters like registration expiration value etc. In an embodiment the source EES sends the response as part of the ACR response. In an alternate embodiment the target EES sends the response as part of the EEC registration response or the ACR response. If the target EES is not able to relocate the context information from the source EES, then the target EES can create new context information for the EEC, based on the information available in the request (such as Application client Profile(s) information) and information about the EEC. At step 612, the EEC stores the new EEC Context ID and stores it for future use, such as to register with a new EES later on. If the EEC receives in the response message, an indication (CONTEXT_RELOCATION_FAIL) that the context information relocation has failed, then the EEC may take necessary steps to update the context information like, create the needed subscriptions, inform target EES with additional information and the like. In an embodiment, at step 614, the target EES also indicates the EEC context relocation status (CONTEXT_RELOCATION_FAIL) to the target EAS, which then can take necessary steps to update the context information like, create the needed subscriptions and the like.

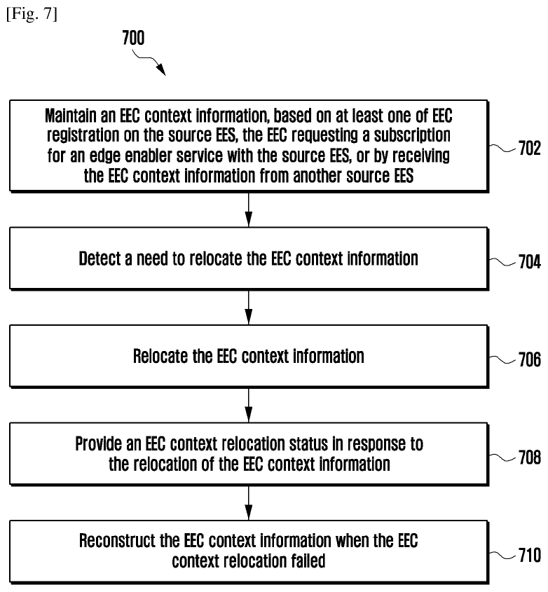

FIG. 7 depicts a method for managing relocating the EEC context information, according to embodiments as disclosed herein. At step 702, the method 700 includes maintaining, by a source EES (EES), an EEC context information about the EEC, based on at least one of EEC registration on the source EES, the EEC requesting a subscription for an edge enabler service with the source EES, or by receiving the EEC context information from another source EES. At step 704, the method 700 includes detecting, by the EES, a need to relocate the EEC context information. At step 706, the method 700 includes relocating the EEC context information to the target EES. In an embodiment, the source EES detects the need to push the EEC context to a target EES. In an alternate embodiment, the target EES detects the need to pull the EEC context from the source EES. At step 708, the method 700 includes providing, by the EES, an EEC context relocation status in response to the relocation of the EEC context information. At step 710, the method 700 includes reconstructing, by the target EES with the help of EEC and the EAS, the EEC context information when the EEC context relocation failed.

The embodiments disclosed herein can be implemented through at least one software program running on at least one hardware device and performing network management functions to control the elements. The elements can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of at least one embodiment, those skilled in the art will recognize that the embodiments herein can be practiced with modification within the spirit and scope of the embodiments as described herein

1. A method performed by a source edge enabler server (EES) for managing relocating an edge enabler client (EEC) context information, the method comprising:
maintaining an EEC context information based on at least one of EEC registration on the source EES, the EEC requesting a subscription for an edge enabler service with the source EES, or by receiving the EEC context information from another source EES;
detecting a need to relocate the EEC context information to target EES; and
relocating the EEC context information to the target EES.

2. The method of claim 1, further comprising:
providing an EEC context relocation status in response to the relocation of the EEC context information,
wherein the EEC context information is reconstructed in case that the EEC context relocation failed.

3. The method of claim 1,
wherein detection of the need for relocation is based on at least one of a request from the EEC, a request from the edge application server, a request from another EES or detecting mobility of the UE hosting the EEC.

4. The method of claim 1,
wherein the EEC context relocation status includes of one of successful status or failed status of relocation.

5. The method of claim 1,
wherein the EEC context relocation status is provided to the EEC by the source EES as part of an application context relocation (ACR) complete notification.

6. The method of claim 1,
wherein the EEC context relocation status is provided to the EEC or an edge application server (EAS) by the target EES in response to one of the EEC registration request or the application context transfer (ACT) status update request.

7. The method of claim 4,
wherein the EEC on receiving the failed EEC context relocation status, performs necessary operations, and
wherein the necessary operations comprises subscribing for required events, to help reconstruct the EEC context information at the target EES.

8. A source edge enabler server (EES) comprising:
an edge enabler client (EEC) controller,
wherein the EEC controller is configured to:
maintain an EEC context information about the EEC based on at least one of EEC registration on the source EES, the EEC requesting a subscription for an edge enabler service with the source EES, or by receiving the EEC context information from another source EES, detect a need to relocate the EEC context information to target EES, and
relocate the EEC context information to the target EES.

9. The source EES of claim 8, wherein the EEC controller is configured to:
provide an EEC context relocation status in response to the relocation of the EEC context information,
wherein the EEC context information is reconstructed in case that the EEC context relocation failed.

10. The source EES of claim 8,
wherein detection of the need for relocation is based on at least one of a request from the EEC, a request from the edge application server, a request from another EES or detecting mobility of the UE hosting the EEC.

11. The source EES of claim 8,
wherein the EEC context relocation status includes of one of successful status or failed status of relocation.

12. The source EES of claim 8,
wherein the EEC context relocation status is provided to the EEC by the source EES as part of an application context relocation (ACR) complete notification.

13. The source EES of claim 8,
wherein the EEC context relocation status is provided to the EEC or an edge application server (EAS) by the target EES in response to one of the EEC registration request or the application context transfer (ACT) status update request.

14. The source EES of claim 10,
wherein the EEC on receiving the failed EEC context relocation status, performs necessary operations, and
wherein the necessary operations comprises subscribing for required events, to help reconstruct the EEC context information at the target EES.
